(19) United States
(12) Patent Application Publication
(10) Pub. No.: US 2001/0004521 A1
(43) Pub. Date: Jun. 21, 2001

(54) METHOD AND APPARATUS FOR TEACHING VIRTUES

(76) Inventor: LINDA DIAL, ATLANTA, GA (US)

Correspondence Address: GERALD R BOSS, TROUTMAN SANDERS, 600 PEACHTREE ST NE, STE 5200, ATLANTA, GA, 303082216

(21) Appl. No.: 09/050,245

(22) Filed: Mar. 30, 1998

(51) Int. Cl. G09B 19/00

(52) U.S. Cl. 434/245

(57) ABSTRACT

A method of teaching virtues including the step of providing a doll and associating a virtue with the doll. A communication medium contains a definition of the virtue and a quote of the virtue for impressing the virtue to an individual.

### BACKGROUND OF THE INVENTION

This invention relates generally to angelic dolls, and more particularly to a set of angelic dolls wherein each doll has a different virtue associated with it. The virtues are described with simplistic language in combination with a famous quote articulating the virtue for teaching virtues to children and enabling them to demonstrate the virtue by presenting the doll to another individual.

The practice of virtues is important in maintaining a peaceful and harmonious society. However, many commentators report that the American society is in a state of disharmony, especially among teenagers and youths. While recent trends indicate that the overall crime rate is declining, juvenile crime has exploded. Between 1985 and 1995 the rate at which 14-17 year old teenagers murdered people rose 165 percent and the Department of Justice has stated that if the current trend continues, this number will double by the year 2010. In addition to an increase in crime, there has been an increase in illegitimate births and drug usage. One report states that more than 400,000 violent crimes are reported in and around U.S. schools each year and that each hour, more than 2,000 students and nearly 40 teachers are attacked on school grounds. Recently, two middle school students were accused of shooting four classmates and a teacher in Arkansas. Also two other recent school shootings occurred in Kentucky and Mississippi where teenagers were charged with killing other teenagers.

One commentator has stated that “the rampant crime is the end result of declining morals, [and the] erosion of traditional values . . . Solutions require a fundamental reassessment and overhauling of basic values that undergird civil society.” Another commentator has stated that “society must provide the intellectual and moral education of the young as the fundamental purpose of education.”

Currently, schools have instituted various programs to emphasize the value of virtues to children. A school in Albuquerque, N.Mex. established a program called “Character Counts!” which focuses on teaching character to school children. The character education incorporates six virtues into the life of the school. These virtues are trustworthiness, respect, responsibility, fairness, caring and citizenship. The director of this program states that the program is based on the belief that there are enduring, universal moral truths which distinguish right from wrong and define the essence of good character.

Another school in Franklin, Mass. has created a “Forest of Virtues” in the foyer of the school. The forest consists of tree trunks which represent justice, fortitude, prudence and temperance. When a student observes another person in the school exhibiting one of the virtues, that person may be nominated to receive a leaf on one of the respective trees. At a schoolwide meeting, the person nominated is recognized in front of the student body and receives a leaf to place upon a tree. The founder of this program states “The forest becomes more and more lush as the year passes.” Thus, the reinforcement of virtues by recognizing the virtuous act increases the actual performance of virtuous activities.

Dolls of various types have been used for many purposes. The famous Barbie® doll illustrates a doll that is used for entertainment enabling children to participate in imaginary settings. Instructional dolls have also been used for training persons in CPR. Furthermore, dolls and other toys have been utilized as gifts which are exchanged from one person to another as a sign of friendship. However, no doll currently is designed to impress virtues onto children or as a token of a virtue expressed from one person to another.

Thus, there is a need for a teaching method for teaching virtues to children while also enabling children and adults to convey a virtue to another person.

Accordingly, it is an object of the present invention to provide a means for teaching and expressing virtues to children and for enabling a person to convey a virtue to another person.

It is also an object of the present invention to provide a celestial doll in combination with a virtue for impressing the virtue onto an individual;

Furthermore, it is an object of the present invention to provide a celestial doll having an associated virtue wherein, the virtue is explained with an easy-to-understand definition and a quote from a famous individual to impress upon the individual the nature of the virtue.

### SUMMARY OF THE INVENTION

A method for teaching virtues which includes the steps of providing a doll and associating a virtue with the doll.

### DESCRIPTION OF THE DRAWINGS

The construction designed to carry out the invention will hereinafter be described, together with other features thereof.

The invention will be more readily understood from a reading of the following specification and by reference to the accompanying drawings forming a part thereof, wherein an example of the invention is shown and wherein:

FIG. 1 is a perspective view of a celestial doll for teaching a virtue according to the present invention;

FIGS. 2A, 2B, and 2C illustrate messages defining a virtue associated with a respective celestial doll displaced on a hang tag which is attached to the doll for teaching a virtue according to the present invention;

FIG. 3 illustrates the presenting of celestial dolls having virtues from one individual to another representing a showing of that particular virtue according to the present invention.

### DESCRIPTION OF THE PREFERRED EMBODIMENT

As shown in FIG. 1 celestial doll A resembles an angel having a head 10, legs 12, arms 14 and wings 16. In the preferred embodiment, celestial doll A resembles a child, but other configurations such as animals having innocent expressions may be used. Message 18 is associated with celestial doll A for expressing a virtue. To convey a virtue, doll A includes a communication medium for communicating the virtue. For instance, doll A may include expressions or other symbols for conveying the virtue. In the preferred embodiment, communication medium 18 includes a short phrase 20 describing the virtue in a short sentence which is easy to understand. Also, in the preferred embodiment, a quote 22 from a famous individual associated with the virtue is included further conveying the importance of the virtue. In the preferred embodiment, communication medium 18 includes hang-tag 24connected to celestial doll A to continuously remind an individual of the virtue associated with the doll. The combination of the celestial doll with the virtue imparts the notion that virtues are important and associated with a divine quality. This establishes an association with the practice of that particular virtue as being divined.

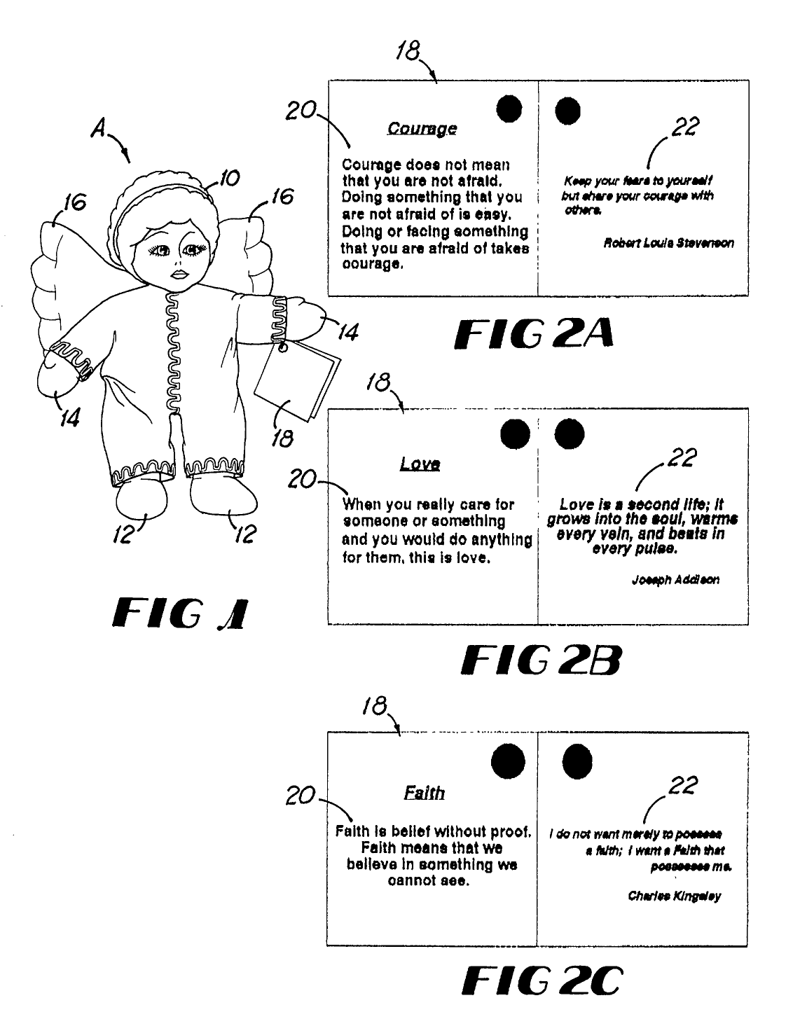

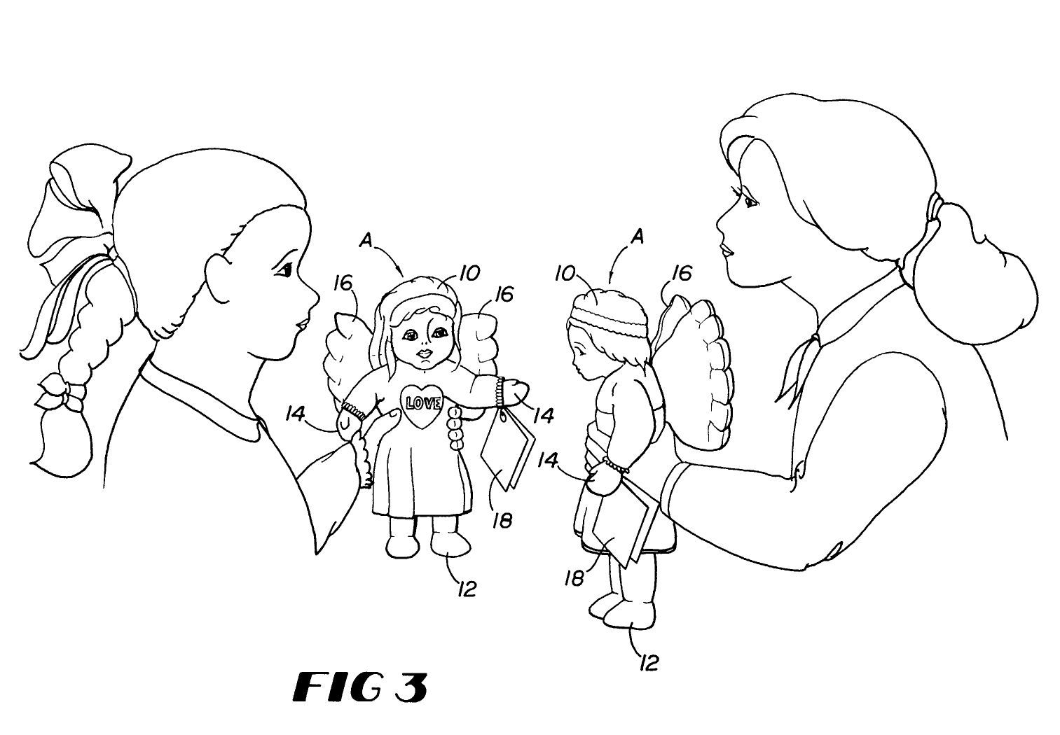

FIGS. 2A, 2B and 2C illustrate a close up of various hang tags 24 identifying separate virtues of which one will be associated with a particular celestial doll A. With a short description of a virtue and an associated famous quote. For instance, as shown in FIG. 2A, the virtue of “COURAGE” is defined on a first side of a hang tag in simple words so that a child could understand them. “COURAGE” may be defined as “Courage does not mean that your are not afraid. Doing something that you are not afraid of is easy. Doing or facing something that your are afraid of takes courage. To complement the definition of the virtue “COURAGE”, a quote from a famous person is positioned on a separate side of the hang tan. For instance, for “COURAGE”, a quote from Robert Louis Stevenson is used. FIG. 2B illustrates the short phrase 20 for the virtue “LOVE”. “LOVE” is defined on a first side of hang tag 24 as “when you really care for someone or something and you would do anything for them, this is love.” To complement the definition of the virtue “LOVE”, a quote from a famous individual is positioned on a separate side of the hang tag. For instance, for “LOVE”, a quote from Joseph Addison may be cited. FIG. 2C illustrates the message for the virtue “FAITH”.

Several virtues may be incorporated into a set of celestial dolls with each celestial doll being associated with a particular virtue. Examples of virtues which are included in the set are Abundance, Belief, Caring, Charity, Citizenship, Confidence, Courage, Fairness, Faith, Forgiveness, Fortitude, Friendship, Generosity, Grace, Gratitude, Honor, Hope, Integrity, Joy, Justice, Kindness, Love, Loyalty, Peace, Prudence, Respect, Responsibility, Self-esteem, Serenity, Spirit, Success, Temperance, Thoughtfulness, Trust, Trustworthiness, Understanding, and Wisdom.

FIG. 3 illustrates the teaching of virtues by presenting a celestial doll A with a particular virtue to a child. For instance, a child may be rewarded for displaying a certain virtue such as “COURAGE” by a parent. The parent presents a celestial doll associated with the virtue “COURAGE” to the child which reinforces the significance and importance of displaying such a virtue. The parent or child may read the message associated with the virtue for explaining the virtue in terms understood by the child. Furthermore, by being presented with a gift in response to the exhibition of the particular virtue, the child associates the performance of the particular virtue as being a positive act and is provided an incentive to perform other virtuous acts. By associating the virtue with a celestial dolls, the child may play with the doll and by having the virtue prominately displayed with the celestial doll the child is reminded of that particular virtue and the importance of the practice of the virtue.

Additionally, individuals may exchange celestial dolls A with one another as a form of expression. For example, a child may present a celestial doll associated with “LOVE” to a parent. Also, children may exchange celestial dolls to one another. For instance, a first child may exchange a doll associated with “LOVE” for a doll associated with “FRIENDSHIP.” In this scenario, the first child might say “I will give you LOVE if you give me FRIENDSHIP.” Thus, each child conveys a virtue to another child producing a harmonious setting, fostering good will and ultimately reducing the proliferation of character traits which lead to crime. Also, an adult may present a celestial doll to another to express that particular virtue. For instance, one may offer a celestial doll associated with “RESPECT” or “SUCCESS”

Thus, it may be seen that a method of teaching virtues may be obtained according to the present invention by providing a celestial doll having a virtue associated with that particular doll and instructing the meaning of the virtue in association with a famous quote for further understanding of the virtue. The celestial medium denotes that the virtue is divine and important. The medium also enables individuals to express the virtue by presenting the celestial doll with a particular virtue to another as either a reward or expression. By incorporating a virtue with a doll, the doll may be displayed in a manner which reminds individuals of virtuous conduct.

What is claimed is:

1. A method for teaching virtues, said method comprising the steps of:
(a) providing a doll; and
(b) associating a virtue with said doll.

2. The method of teaching virtues of claim 1 further including the step of attaching a communication medium to said doll wherein said communication medium contains an inscription of said virtue on said communication medium.

3. The method of teaching virtues of claim 2 further including providing a quote which incorporates said virtue on said communication medium.

4. The method of teaching virtues of claim 1 wherein said virtue is selected from the group consisting of abundance, belief, caring, charity, citizenship, confidence, courage, fairness, faith, forgiveness, fortitude, friendship, generosity, grace, gratitude, honor, hope, integrity, joy, justice, kindness, love, loyalty, peace, prudence, respect, responsibility, self-esteem, serenity, spirit, success, temperance, thoughtfulness, trust, trustworthiness, understanding, and wisdom.

5. The method of teaching virtues of claim 1 further including the step of displaying said virtue on said doll whereby said virtue is visible when looking at said doll.

6. A doll for demonstrating virtues to an individual, said doll comprising:
a body;
a pair of wings attached to said body; and
a communication medium connected to said body, wherein said communication medium incorporates a name of a virtue and a description of said virtue.

7. The doll of claim 6 further including a quote incorporating said virtue integral with said communication medium.

8. The doll of claim 7 wherein said communication medium includes a hang-tag having a first side and a second side wherein said name of said virtue is inscribed on said first side and said quote incorporating said virtue is inscribed on said second side.

9. The doll of claim 6 wherein said virtue is selected from the group consisting of abundance, belief, caring, charity, citizenship, confidence, courage, fairness, faith, forgiveness, fortitude, friendship, generosity, grace, gratitude, honor, hope, integrity, joy, justice, kindness, love, loyalty, peace, prudence, respect, responsibility, self-esteem, serenity, spirit, success, temperance, thoughtfulness, trust, trustworthiness, understanding, and wisdom.
